(19) United States
(12) Patent Application Publication
(10) Pub. No.: US 2025/0007627 A1
(43) Pub. Date: Jan. 2, 2025

(54) METHOD FOR TRANSMITTING DATA IN A CELLULAR COMMUNICATION NETWORK

(71) Applicant: SAGEMCOM BROADBAND SAS, Bois-Colombes (FR)

(72) Inventor: Frédéric DE GRAEVE, Bois-Colombes (FR)

(73) Assignee: SAGEMCOM BROADBAND SAS, Bois-Colombes (FR)

(21) Appl. No.: 18/747,963

(22) Filed: Jun. 19, 2024

(30) Foreign Application Priority Data
Jun. 27, 2023 (FR) 2306715

(51) Int. Cl. H04B 17/15; H04B 7/0413; H04B 7/06

(52) U.S. Cl. CPC H04B 17/15; H04B 7/0413; H04B 7/0608

(57) ABSTRACT

An end device including a plurality of transmission antennas, a combination of which is selected for making a data transmission to a base station of a cellular communication network. In test phase, for each possible combination of transmission antennas: the end device transmits test data and monitors what effect each possible combination of transmission antennas has on parameterisations made by the base station with respect to the end device in the cellular communication network. The end device deduces therefrom uplink quality metrics obtained with each combination of transmission antennas. Then, in nominal transmission phase, the data are transmitted by activating the combination of transmission antennas that obtained the best uplink quality metrics in test phase.

### TECHNICAL FIELD

The present invention relates to a method for transmitting data from an end device to a base station in a cellular communication network. More particularly, the present invention relates to selecting a combination of transmission antennas to make a transmission of data from the end device to the base station.

### PRIOR ART

In cellular communication systems, such as 4G (“4th Generation”) or 5G (“5th Generation”), communication devices comprise a plurality of antennas available for reception and/or a plurality of antennas available for transmission. A subset of these antennas is then selected to implement communications between the communication devices.

In the case of a symmetrical communication channel, for example in DECT (“Digital Enhanced Cordless Telecommunications”), measuring a level of the signal received from a remote device successively on a plurality of antennas, and adopting the antenna offering the best result as antenna used both in reception and in transmission subsequently, is in particular known. However, such an approach loses its efficacy to the detriment of the transmitter with the lowest power, since the powers used by the two remote devices are very asymmetric, which is the case in cellular communications between a base station and a mobile station (or end device). This is because the mobile station typically transmits signals with a power of a few tens of milliwatts whereas the base station typically transmits signals with a power of several watts.

It is also known, in cellular communication networks, that the base station receives, from the mobile stations, downlink-quality information. The base station is also capable of measuring the uplink quality. From this information received and these measurements made, the base station is capable of implementing a cell parameterisation, and in particular instructing the mobile stations as to the modulation and coding scheme to be used, the transmission power to be used, etc.

This situation is shown schematically on FIG. 1, where, in a step 151, a base station BS transmits data to a mobile station MS. In a step 152, the mobile station MS makes downlink-quality measurements (signal level, signal-to-noise ratio, block error rate, etc), and in a step 153 transmits data to the base station BS that include information representing the downlink-quality measurements made by the mobile station MS. Receiving the data transmitted by the mobile station MS, the base station BS makes uplink-quality measurements (signal level, signal-to-noise ratio, block error rate, etc) in a step 154. Then, in a step 155, the base station decides how to adjust the parameterisations of the mobile station MS to improve the communication quality in the cellular communication network. Then, in a step 156, the base station BS transmits to the mobile station MS a message including instructions as to the modulation and coding scheme to be used, the transmission power to be used, etc.

However, such an approach cannot be used by the mobile station since there does not exist any message for obtaining from the base station its own information on reception conditions, i.e. uplink-quality information. In addition, because of great asymmetry of the transmission powers involved between the base station and the mobile station, extrapolating downlink-quality indicators for estimating an uplink quality is not sufficiently precise to determine the efficacy of several combinations of antennas.

Moreover, asymmetry between downlink and uplink may arise when the bands in which the respective transmissions and receptions take place are different. This asymmetry may occur when the 4G and/or 5G protocols use a Frequency Division Duplexing “FDD” radio access technology.

It is then desirable to overcome these drawbacks of the prior art with a solution that enables a mobile station (or end device) to select a transmission antenna configuration to be used for transmitting data to the base station while the base station does not supply to the mobile station (or end device) signal quality information received from the mobile station (or end device).

### DISCLOSURE OF THE INVENTION

A method is proposed here for transmitting data from an end device over an uplink to a base station in a cellular communication network, the end device comprising a plurality of transmission antennas a combination of which is selected for making the data transmission from the end device to the base station, the method being implemented by the end device. The method comprises, in test phase, for each possible combination of transmission antennas: transmitting test data to the base station by activating the combination of transmission antennas in question; and monitoring what effect the combination of transmission antennas in question has on parameterisations made by the base station with respect to the end device in the cellular communication network, and deducing therefrom uplink quality metrics obtained with the combination of transmission antennas in question. In addition, the method comprises, in nominal transmission phase: implementing the data transmission by activating the combination of transmission antennas that obtained the best uplink quality metrics in test phase. The effect on the parameterisations made by the base station is monitored by collecting at regular intervals an instantaneous transfer block size value from a physical layer of a communication interface of the end device with the cellular communication network, the metrics being such that, the greater the transfer block size, the better the uplink quality.

Thus, by virtue of the monitoring of the effect of the combinations of transmission antennas tested on the parameterisations made by the base station with respect to the end device in the cellular communication network, it is possible to select a configuration of transmission antennas suitable for transmitting data to the base station, while the base station does not provide to the end device signal quality information received from the end device.

According to a particular embodiment, the effect on the parameterisations made by the base station is monitored using also the modulation and coding scheme defined by the base station for the end device, and the metrics are such that, the more robust the modulation and coding scheme, the less good is the uplink quality.

According to a particular embodiment, the effect on the parameterisations made by the base station is furthermore monitored using also a number of MIMO (Multiple Inputs-Multiple Outputs”) layers enabled by the base station, and the metrics are such that, the greater the number of MIMO layers, the better the uplink quality.

According to a particular embodiment, the effect on the parameterisations made by the base station is monitored using also a transmission power control value sent by the base station to the end device, and the metrics are such that, the lower the transmission power, the better the uplink quality.

According to a particular embodiment, the method comprises: adopting only the best uplink quality metrics obtained by iterating the test phase for each combination of transmission antennas tested.

According to a particular embodiment, the method comprises: implementing several test phase iterations, and calculating mean metrics on said iterations, for each combination of transmission antennas tested.

According to a particular embodiment, the method comprises: accumulating statistics over a period T greater than or equal to a predefined duration threshold TH1, in the form of a history of at least one set of uplink quality metrics obtained during successive iterations of the test phase; and removing from the history the metrics values that deviate from their mean beyond a predefined distance threshold TH2.

According to a particular embodiment, the predefined distance threshold TH2 is equal to twice the standard deviation.

According to a particular embodiment, the predefined duration threshold TH1 is equal to a few sliding days.

According to a particular embodiment, the test phase is triggered when a movement of the end device is detected by means of measurements from an accelerometer mounted integral with the end device.

According to one particular embodiment, the end device is a residential gateway.

An end device (such as a residential gateway) is also proposed, configured to transmit data over an uplink to a base station of a cellular communication network, the end device comprising a plurality of transmission antennas a combination of which is selected for making the data transmission from the end device to the base station. The end device comprises electronic circuitry configured for, in test phase, for each combination of transmission antennas: transmitting test data to the base station by activating the combination of transmission antennas in question; and monitoring what effect the combination of transmission antennas in question has on parameterisations made by the base station with respect to the end device in the cellular communication network, and deducing therefrom uplink quality metrics obtained with the combination of transmission antennas in question. In addition, the electronic circuitry is configured for, in nominal transmission phase: making the data transmission by activating the combination of transmission antennas that obtained the best uplink quality metrics in test phase. The electronic circuitry is configured so that the effect on the parameterisations made by the base station is monitored by collecting at regular intervals an instantaneous transfer block size value from a physical layer of a communication interface of the end device with the cellular communication network, the metrics being such that, the greater the transfer block size, the better the uplink quality.

A computer program is also proposed here, comprising program code instructions causing an implementation of the method disclosed above in any one of its embodiments, when said instructions are executed by a smart-meter processor. An information storage medium storing such program code instructions is also proposed here.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically exchanges between a base station and a mobile station, according to the prior art;

FIG. 2 illustrates schematically a communication system wherein one or more embodiments can be implemented;

FIG. 3 illustrates schematically an arrangement of a communication interface adapted to a cellular communication network;

FIG. 4 illustrates schematically an algorithm for configuring the communication interface of FIG. 3, by executing a test phase;

FIG. 5 illustrates schematically an algorithm for regularly triggering the test phase; and

FIG. 6 illustrates schematically an example of a hardware arrangement of a configurator of the communication interface of FIG. 3.

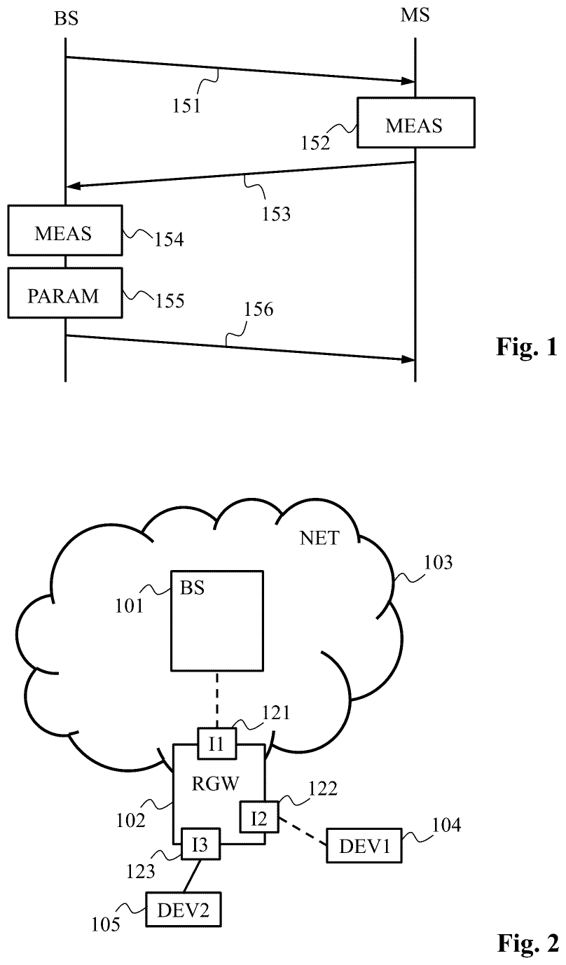

### DETAILED DISCLOSURE OF EMBODIMENTS

FIG. 2 illustrates schematically a communication system wherein one or more embodiments can be implemented.

The communication system comprises a cellular communication network NET 103, with a base station BS 101. The cellular communication network NET 103 is a cellular telephony network, for example of the 4G or 5G type. Depending on the technology of the cellular communication network NET 103, the base station BS 101 may commonly be referred to by another term, for example “eNodeB”. The cellular communication network NET 103 operating under the 4G and/or 5G standard may also be configured for Frequency Division Duplexing (FDD) or Time Division Duplexing (TDD).

The communication system comprises an end device 102, also referred to as a “mobile station” or “user equipment” (UE).

In a preferred embodiment, the end device 102 is a residential gateway RGW. Such an arrangement has the particularity that the communication channel between the base station BS 101 and the residential gateway RGW 102 is more stable than in the case where the end device 102 is destined to be frequently moved (as a mobile telephone would be, for example).

The residential gateway GW 102 comprises a communication interface I1 121 enabling the residential gateway RGW 102 to communicate, wirelessly, with the base station BS 101 in the context of the cellular communication network NET 103.

The residential gateway RGW 102 comprises, by way of illustration, a communication interface I2 122 making it possible to communicate, wirelessly, with one or more end devices DEV1 104. For example, the communication interface I2 122 is of the Wi-Fi type, and the end device DEV1 104 is a TV set-top box, a tablet, a computer, etc.

The residential gateway RGW 102 comprises, by way of illustration, a communication interface I3 123 making it possible to communicate, by wire, with one or more end devices DEV2 105. For example, the communication interface I3 123 is of the Ethernet type, and the end device DEV2 105 is a TV set-top box, a computer, etc.

Thus the residential gateway RGW 102 implements router functionalities enabling the end devices DEV1 104 and DEV2 105 to access Wide Area Network (WAN) services, such as internet services, via the cellular communication network NET 103.

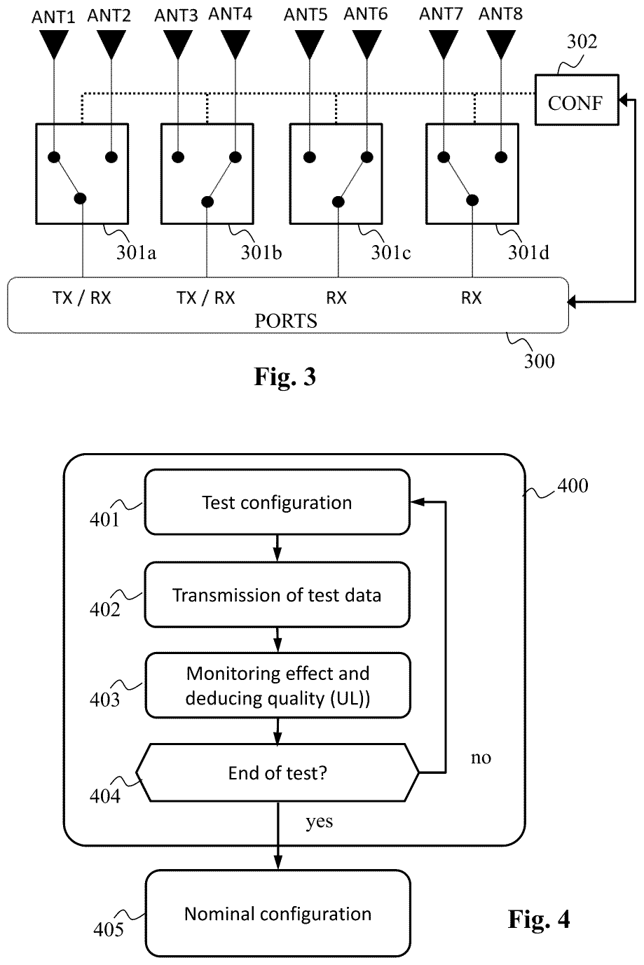

FIG. 3 illustrates schematically an arrangement of the communication interface I1 121. The communication interface I1 121 comprises a plurality of antennas that can be used in reception (by means of a reception port RX), so as to receive communication signals coming from the base station BS 101. The communication interface I1 121 comprises a plurality of antennas that can be used in transmission (by means of a transmission port TX), so as to send communication signals to the base station BS 101. One or more antennas can be used in transmission and in reception (by means of a transmission-reception port TX/RX).

By way of illustration, the arrangement in FIG. 3 has eight antennas ANT1 to ANT8. The antennas are associated in pairs. Switches 301a to 301d make it possible to selectively activate, by dynamic configuration, one antenna for each pair, and to deactivate the other antenna in the pair in question. Thus the combinations of transmission antennas made possible by the arrangement in FIG. 3 are as follows: ANT1+ANT3, ANT1+ANT4, ANT2+ANT3 and ANT2+ANT4. In other examples the communication interface I1 121 comprises:
4 antennas and 2 switches, or
6 antennas and 3 switches, or
etc.

The dynamic configuration of the switches 301a to 301d is implemented by a configurator CONF 302. In one example, the configurator CONF 302 comprises, or is able to cooperate with, a modem or a baseband controller of the physical and MAC layers compatible with cellular communication protocols (for example 4G and/or 5G).

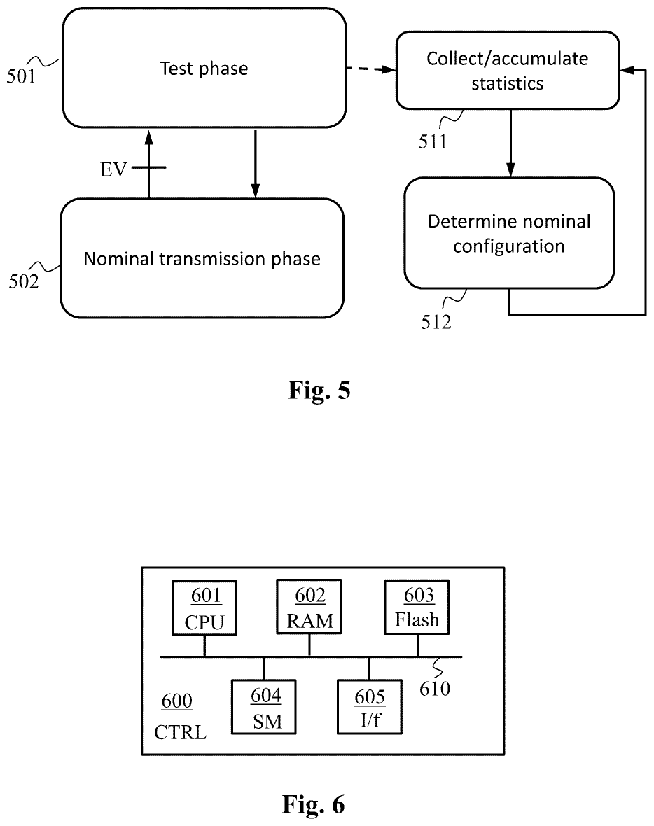

The configurator CONF 302 implements a test phase for determining which combination of transmission antennas to use in nominal transmission phase (i.e. outside the test phase). Each of the combinations of transmission antennas possible is then tested. And by monitoring what effect each combination of transmission antennas has on parameterisations made by the base station BS 101 with respect to the residential gateway GW 102 in the cellular communication network NET 103, this makes it possible to deduce therefrom uplink quality metrics obtained with the combination of transmission antennas in question. And the combination of transmission antennas that obtained the best uplink quality metrics in test phase is then used in nominal transmission phase. This aspect is detailed below in relation to FIGS. 4 and 5.

FIG. 4 illustrates schematically an algorithm for configuring the communication interface I1 121. The algorithm in FIG. 4 makes it possible to establish a test phase 400 during which various combinations of transmission antennas are tested.

In a step 401, the configurator CONF 302 selects a combination of transmission antennas to be tested. In the context of FIG. 3, the configurator CONF 302 configures the switches 301a to 301d so as to activate the combination of transmission antennas that is selected (i.e. combination of transmission antennas to be tested).

In a step 402, the configurator CONF 302 triggers a transmission of test data to the base station BS 101. The test data can be sent to a server made accessible by the cellular communication network NET 103 via the base station BS 101.

The test data are thus transmitted by the residential gateway RGW 102 via its communication interface I1 121 using the combination of transmission antennas that was selected at the step 401.

In a step 403, the configurator CONF 302 monitors what effect the combination of transmission antennas that is used at the step 402 has on parameterisations made by the base station BS 101 with respect to the residential gateway GW 102 in the cellular communication network NET 103. From this effect, the configurator CONF 302 deduces therefrom uplink quality metrics obtained with the combination of transmission antennas that was selected at the step 401.

In a particular embodiment, the configurator CONF 302 interrogates, for example every 100 ms, the communication interface I1 121 (e.g. a set of components (“chipset”) implementing a physical layer compatible with the cellular communication network NET 103) in order to collect at regular intervals an instantaneous value of a parameter called “Transfer Block Size” or TB size) The transfer block size is a good indicator of the ability to obtain a satisfactory uplink throughput, which corresponds to the size of payload blocks sent to the physical layer and defines the usage of the radio medium between the residential gateway GW 102 and the base station BS 101. The transfer block size results from a physical layer calculation, which depends on the following parameters imposed by the base station BS 101: number of MIMO (“Multiple Input-Multiple Output”) layers, modulation and coding scheme, and number of resource blocks allocated in uplink by the base station BS 101 to the residential gateway GW 102. The transfer block size therefore reveals the effect of the combination of transmission antennas tested on parameterisations made by the base station BS 101 with respect to the residential gateway GW 102 in the cellular communication network NET 103. The configurator CONF 302 deduces therefrom uplink quality metrics obtained with the combination of transmission antennas in question, considering that, the greater the transfer block size, the better the performance (quality) of the uplink.

In another particular embodiment, the configurator CONF 302 uses the modulation and coding scheme MCS defined by the base station BS 101 for the transmissions from the residential gateway GW 102 to said base station BS 101. The base station BS 101 typically defines the modulation and coding scheme MCS to be used in uplink, according to a block error rate (BLER) of the data received coming from the residential gateway GW 102. The modulation and coding scheme therefore reveals the effect of the combination of transmission antennas tested on parameterisations made by the base station BS 101 with respect to the residential gateway RGW 102 in the cellular communication network NET 103. The configurator CONF 302 deduces therefrom uplink quality metrics obtained with the combination of transmission antennas in question, considering that, the more robust the modulation and coding scheme MCS, the less good the performance (quality) of the uplink. For example, the modulation and coding schemes MCS that can be used are noted as an index with increasing value according to the number of bits that can be transported by a single symbol to which the modulation and coding scheme MCS in question is applied. Thus the higher the index, the better the performance (quality) of the uplink.

In another particular embodiment, apart from the modulation and coding scheme MCS, the configurator CONF 302 uses the number of MIMO layers enabled by the base station BS 101 for the residential gateway RGW 102. The number of MIMO layers corresponds to the number of different streams that the residential gateway GW 102 is enabled to transmit in uplink by the base station BS 101, typically according to what is allowed by the quality of the radio signal received from the residential gateway GW 102. The number of MIMO layers therefore also reveals the effect of the combination of transmission antennas tested on parameterisations made by the base station BS 101 with respect to the residential gateway RGW 102 in the cellular communication network NET 103. The configurator CONF 302 deduces therefrom uplink quality metrics obtained with the combination of transmission antennas in question, considering that the larger the number of MIMO layers, the better the performance (quality) of the uplink. For example, the configurator CONF 302 can establish metrics based on a product of the index of the modulation and coding scheme MCS multiplied by the number of MIMO layers.

In another particular embodiment, the configurator CONF 302 uses a Transmit Power Control (TPC) value sent by the base station BS 101 to the residential gateway RGW 102. The transmit power control value indicates to the residential gateway RGW 102 how to adjust the transmission power, such as for example in closed loop control CLC in 4G or 5G. The lower the transmission power, the better the performance (quality) of the uplink.

In another particular embodiment, the configurator CONF 302 uses metrics derived from several metrics disclosed above, for example metrics that take into account the index of the modulation and coding scheme MCS, the number of MIMO layers and the transmission power control value

Advantageously, to reject any transient phase at the start of transmission, the configurator CONF 302 adopts only the best uplink quality metrics obtained by iterating the test phase for each combination of transmission antennas tested. For example: the maximum value among the transfer block size values collected for each combination of transmission antennas tested, or the minimum value among the transmission power control values collected for each combination of transmission antennas tested.

Advantageously also, the configurator CONF 302 implements several iterations (for example 10 to 20 iterations) of the test phase, and calculates mean metrics on said iterations, for each combination of transmission antennas tested, in order to smooth any variations in radio environments and network occupation.

In a step 404, the configurator CONF 302 checks whether there remains at least one other combination of transmission antennas to be tested during the test phase 400; if such is the case, the test phase 400 continues, and the step 401 is reiterated by selecting a new combination of transmission antennas to be tested. All the possible combinations of transmission antennas can thus be tested during the test phase 400. The tests of all the possible combinations of transmission antennas can also be distributed over several iterations of the test phase 400.

In a step 405, at the end of the test phase 400, the configurator CONF 302 selects a nominal configuration among the configurations of transmission antennas that have been tested. The nominal configuration is the configuration of transmission antennas that shows the best uplink quality metrics among the configurations of transmission antennas that have been tested, in light of their effect on the parameterisations made by the base station BS 101 with respect to the residential gateway GW 102 in the cellular communication network NET 103.

The nominal configuration is then the configuration of transmission antennas that is used in nominal transmission phase, i.e. when the residential gateway RGW 102 transmits to the base station BS 101 data other than the test data (i.e. outside the test phase).

The test phase 400 can be triggered by the residential gateway RGW 102 at various moments:
when the residential gateway RGW 102 is switched on;
periodically, for example between once per hour and once per day;
at a connection/reconnection to the cellular communication network NET 103;
when a movement of the residential gateway RGW 102 is detected, by means of measurements of an accelerometer mounted integral with (e.g. integrated in) said residential gateway RGW 102;
when a user command is detected, such as pressing on a button of a man-machine interface of the residential gateway RGW 102;
or in general terms when the occurrence of a predefined event is detected.

FIG. 5 illustrates schematically an algorithm for regularly triggering the test phase described above in relation to the algorithm in FIG. 4.

After initialisation, the residential gateway RGW 102 triggers a test phase 501.

The test phase 501 consists of testing various combinations of transmission antennas, as explained above in relation to FIG. 4. The metrics used can be the same as those detailed above in relation to FIG. 4.

Once the test phase 501 has ended, the residential gateway GW 102 switches into nominal transmission phase. In transmission, the residential gateway RGW 102 uses a nominal configuration of the transmission antennas. This nominal configuration of the transmission antennas is obtained by means of statistics accumulated, in a step 511, during successive iterations of the test phase 501.

This is because, at each iteration of the test phase 501, the residential gateway RGW 102 enhances uplink quality statistics, i.e. a history of at least one set of uplink quality metrics obtained during successive iterations of the test phase. Thus, when the occurrence of a predefined event EV is detected, the residential gateway RGW 102 triggers a new iteration of the test phase 501, and the statistics are then enhanced with this new iteration of the test phase 501. This can lead, in a step 512, to a new definition of the nominal configuration of the transmission antennas (for example because the residential gateway RGW 102 has been moved).

In the step 512, the residential gateway RGW 102 determines the nominal configuration (of the transmission antennas) after having accumulated statistics over a period T greater than or equal to a predefined duration threshold TH1. The predefined duration threshold TH1 is preferentially equal a few sliding days. For example, TH1 is 5 sliding days. Preferentially, the residential gateway RGW 102 (the configurator CONF 302) removes the from the history the metrics values that deviate from their mean beyond a predefined distance threshold TH2. For example, TH2 is equal to twice the standard deviation. In a particular embodiment, the residential gateway RGW 102 applies a Gaussian filter to the history. Thus any metrics that might have been falsified, either by an ephemeral radio environment (e.g. a metal object that has been placed in proximity to the residential gateway RGW 102), or by a reduction in the number of resources available for the residential gateway RGW 102 due to high cell traffic. This statistical approach is unusual in the field of cellular telephony networks, which are specifically designed for supporting particularly mobile end devices, whereas the purpose of the residential gateway RGW 102 is to remain at the same place for a long time.

FIG. 6 illustrates schematically an example arrangement of a controller CTRL 600 incorporating at least the configurator CONF 302, and optionally other functionalities (e.g. communication battery, application functionalities, etc).

The controller CTRL 600 comprises, connected by a communication bus 610: a processor or CPU (“central processing unit”) 601; a random access memory (RAM) 602; a non-volatile memory, for example of the EEPROM (“electrically-erasable programmable read-only memory”) type, or of the flash type 603; a storage unit, such as a storage medium SM 604, for example a hard disk HDD, or a storage medium reader, such as an SD (Secure Digital) card reader; and an interface manager I/f 605.

The interface manager I/f 605 enables the configurator CONF 302 to interact with other elements of the residential gateway RGW 102, particularly the switches 301a to 301d in order to configure the antennas to be used in transmission, whether in test phase or in nominal transmission phase.

The processor or CPU 601 is capable of executing instructions loaded in the random access memory 602, in particular from the non-volatile memory 603 or from the storage medium (such as an SD card) 604. When the controller CTRL 600 is powered up, the processor or CPU 601 is thus capable of reading instructions from the random access memory 602 and executing them. These instructions form a computer program causing in particular the implementation, by the processor or CPU 401, of the steps and behaviours described here in relation to the configurator CONF 302.

All or some of the steps and behaviours described here can thus be implemented in software form by executing a set of instructions by a programmable machine, for example a processor of the DSP (“digital signal processor”) type, or a microcontroller, or be implemented in hardware form by a machine or a dedicated electronic component (chip) or a dedicated set of electronic components (chipset), for example an FPGA (field-programmable gate array) or ASIC (application-specific integrated circuit) component. In general terms, the configurator CONF 302, and more generally the controller CTRL 600 and the residential gateway RGW 102, comprises electronic circuitry adapted and configured to implement the steps and behaviours described here.

1. A method for transmitting data from an end device over an uplink to a base station in a cellular communication network, the end device including a plurality of transmission antennas a combination of which is selected for making the data transmission from the end device to the base station, the method being implemented by the end device, the method comprising, in test phase, for each possible combination of transmission antennas:
transmitting test data to the base station by activating the combination of transmission antennas in question; and
monitoring what effect the combination of transmission antennas in question has on parameterisations made by the base station with respect to the end device in the cellular communication network, and deducing therefrom uplink quality metrics obtained with the combination of transmission antennas in question,
and the method further comprising, in nominal transmission phase:
implementing the data transmission by activating the combination of transmission antennas that obtained the best uplink quality metrics in test phase, characterised in that the effect on the parameterisations made by the base station is monitored by collecting at regular intervals an instantaneous transfer block size value from a physical layer of a communication interface of the end device with the cellular communication network, and in that the metrics are such that, the greater the transfer block size, the better the uplink quality.

2. The method according to claim 1, wherein the effect on the parameterisations made by the base station is monitored using the modulation and coding scheme defined by the base station for the end device, and wherein the metrics are such that, the more robust the modulation and coding scheme, the less good is the uplink quality.

3. The method according to claim 1, wherein the effect on the parameterisations made by the base station is monitored using also a number of MIMO layers enabled by the base station, and wherein the metrics are such that, the greater the number of MIMO layers, the better the uplink quality.

4. The method according to claim 1, wherein the effect on the parameterisations made by the base station is monitored using also a transmission power control value sent by the base station to the end device, and wherein the metrics are such that, the lower the transmission power, the better the uplink quality.

5. The method according to claim 1, comprising:
adopting only the best uplink quality metrics obtained by iterating the test phase for each combination of transmission antennas tested.

6. The method according to claim 1 comprising:
implementing several test phase iterations, and calculating mean metrics on said iterations, for each combination of transmission antennas tested.

7. The method according to claim 1, comprising:
accumulating statistics over a period T greater than or equal to a predefined duration threshold TH1, in the form of a history of at least one set of uplink quality metrics obtained during successive iterations of the test phase;
removing from the history the metrics values that deviate from their mean beyond a predefined distance threshold TH2.

8. The method according to claim 7, wherein the predefined distance threshold TH2 is equal to twice the standard deviation.

9. The method according to claim 7, wherein the predefined duration threshold TH1 is equal to a few sliding days.

10. The method according to claim 1, wherein the test phase is triggered when a movement of the end device is detected by means of measurements from an accelerometer mounted integral with the end device.

11. The method according to claim 1, wherein the end device is a residential gateway.

12. An end device configured to transmit data over an uplink to a base station in a cellular communication network, the end device comprising a plurality of transmission antennas a combination of which is selected for making the data transmission from the end device to the base station,
the end device comprising electronic circuitry configured for, in test phase, for each possible combination of transmission antennas:
transmitting test data to the base station by activating the combination of transmission antennas in question, and
monitoring what effect the combination of transmission antennas in question has on parameterisations made by the base station with respect to the end device in the cellular communication network, and deducing therefrom uplink quality metrics obtained with the combination of transmission antennas in question,
and the electronic circuitry being furthermore configured for, in nominal transmission phase:
making the data transmission by activating the combination of transmission antennas that obtained the best uplink quality metrics in test phase,
characterised in that the electronic circuitry is configured so that the effect on the parameterisations made by the base station is monitored by collecting at regular intervals an instantaneous transfer block size value from a physical layer of a communication interface of the end device with the cellular communication network, the metrics being such that, the greater the transfer block size, the better the uplink quality.

13. (canceled)

14. A non-transitory information storage medium storing program code instructions causing an implementation of the method according to claim 1, when said instructions are read and executed by a processor of an end device.
